(19) United States
(12) Patent Application Publication
(10) Pub. No.: US 2006/0046786 A1
(43) Pub. Date: Mar. 2, 2006

(54) Mobile communication terminal and method

(76) Inventors: Franco Montebovi, Lund (SE); Jens Benner, Copenhagen OE (DK)

Correspondence Address: PERMAN & GREEN, 425 POST ROAD, FAIRFIELD, CT, 06824, US

(21) Appl. No.: 10/932,544

(22) Filed: Sep. 2, 2004

(51) Int. Cl. H04B 17/00

(52) U.S. Cl. 455/566

(57) ABSTRACT

A mobile communications terminal having a display comprising a display and at least one multi color light emitting diode provided adjacent to the display.

### TECHNICAL AREA

The present invention relates to mobile communication terminals and in particular to mobile radio frequency telephones with monochrome displays illuminated by Light Emitting Diodes (LEDs).

### TECHNICAL BACKGROUND

Many mobile communications terminals today that have monochrome displays offer the user few possibilities to express himself or to personalize the mobile communications terminal according to his desires without having to buy extra equipment such as covers. Having a color screen or display sometimes provides some opportunities as the user can change the color of the display according to his desires. However, color displays are quite expensive and therefore not suitable for the low-end market phones.

Another problem with monochrome displays is that they have very limited capabilities of conveying or signalling information to a user without actually writing or drawing it on the screen and this is both costsome as display there are most often many information objects competing to be displayed and only showing someting on the display might be hard to see from a distance or when not looking directly at the display.

### SUMMARY OF THE INVENTION

In view of the above, an objective of the invention is to solve or at least reduce the problems discussed above and to provide an improved mobile communications terminal compared to the prior art.

Generally, the above objective is achieved by a mobile communications terminal according to the attached independent claim. Thus, a first aspect of the invention is a mobile communications terminal comprising a display and at least one multi color light emitting diode provided adjacent to the display.

The ability to show different colors on the screen wihtout using an expensive color screen provides the user with ample opportunity to personalize his or her device. It also provides many possibilities of showing information and especially if the information to be shown is complex.

In an embodiment the said at least one multi color light emitting diode is arranged to illuminate the display according to a color scheme. Having various color schemes that can be changed over time and that may also include some dynamic behavior, such as blinking, provides further Possibilities to personalize a mobile communications terminal, such as a mobile phone. A dynamic behavior is also far more eye-catching than a static shining.

In another embodiment there are more than one multi color light emitting diode which are grouped in at least a first and a second group and the light emitting diodes in respective group are set to emit light according to a color scheme for each said at least first and second group. These groups provide a possibility to divide the screen into various segments for easier control of how to arrange the different colors and behavior of the diodes.

In an embodiment the mobile communications terminal also has a status. In this patent application we regard, among other things, events such as an incoming call being a status.

In a further embodiment the status is associated with at least one color scheme. Visual indications of events and status changes provides a good way of signalling information to a user and is particularly useful when one wants the mobile communications terminal to be quiet as when in a meeting or in a train perhaps. A dynamic color scheme carries many possibilities and advantages when sinalling to a user as it is more eye-catching and offers more possible combinations for coding information.

In anoher embodiment the status is associated with at least one (multicolor light emitting diode) group. Dividing the screen into different sections or segments depending on the grouping provides a good way of visually signalling information to a user as one part of the screen might be associated with a certain task, status, event or behavior whilst the other is associated with subfacts concerning that status or event. It is also good for emphasizing or bringig out some sub fact that is deemed to be more important than the other subfacts.

In another embodiment the status is a congregated status consisting of more than one statuses. Having congregated statuses provides for an easy way of implementing and also informing the user of more complex statuses and information regarding that status such as an incoming call from a caller that is regarded as important and the call has a priority level saying it is urgent, ie the three statuses incoming call, important contact and urgent are grouped into one status.

In an embodiment the mobile communiations terminal is a mobile phone. The present invention is advantageous to implement in mobile phones as these often go through many status changes that need to be indicated to the user and as users have shown a desire to be able to personalize their mobile phones and as the cost requirements for mobile phones are often quite hard.

According to another aspect of the present invention the objectives above are achieved by a mobile communications terminal having a status and comprising display means aranged to be illuminated in at least one color and the at least one color is selectable depending on said status. Showing different colors is a good and intuitive way of visually signal information to a user.

In another embodiment said at least one color is dependent on a color scheme and said color scheme is selectable depending on said status whereby said at least one color is selected accordingly. By having predefined color shcemes a status can be shown in many possibilities and carry additional information that would be vary hard to signal with only one color for the whole display as discussed of the aspect above.

In another embodiment the display means are aranged to be illuminated in at least one segment and the at least one segment is selectable depending on said status. By dividing the display more than one status can be shown or possibly more information pertaining to a specifc status can be shown at the same time.

In another embodiment the status is a congregated status consisting of more than one substatuses and the at least one segment has a color scheme and each of the at least one segment and its color scheme are selectable depending on one of the substatuses of said congregated status. This will help signal useful information to a ser and also to arrange the color schemes and color semgents that will be used to signal the information to the user.

According to another aspect of the invention the objectives above are achieved by a method of illuminating a display of a mobile communications terminal using at least one multicolor light emitting diode arranged adjacent to the display comprising the step of setting at least one color for the at least one multicolor light emitting diode thus providing ample opportunities for the user to personalize the mobile communications terminal.

In an embodiment the method has the alternate step of grouping the light emitting diodes into at least one group (340,350) and setting the color for the multicolor light emitting diode according to which of the at least one group (340,350) it is grouped to. Grouping the diodes is an easy way of dividing or segmenting the screen or display to provide more possibilities for personalizations or information signalling.

In another embodiment the method comprises the further step of achieving information relating to a current status of said mobile communications terminal.

In a further embodiment the method comprises the further step of setting the color of the multicolor light emitting diodes according to the status. Showing different colors according to the status is a simple and effective way of signalling a status change or current status to a user without using extra sound.

Generally, all terms used in the claims are to be interpreted according to their ordinary meaning in the technical field, unless explicitly defined otherwise herein. All references to “a/an/the [element, device, component, means, member, step, etc]” are to be interpreted openly as referring to at least one instance of said element, device, component, means, mebmer, step, etc., unless explicitly stated otherwise.

### BRIEF DESCRIPTION OF THE DRAWINGS

Some embodiments of the present invention will now be described in more detail, reference being made to the enclosed drawings:

FIG. 1 is a schematic illustration of a telecommunications system, in which the present invention may be applied.

FIG. 2 is a schematic block diagram illustrating a mobile communications terminal of FIG. 1 in more detail.

FIG. 3a is a schematic view of a mobile communications terminal having a display and light emitting diodes (LEDs).

FIG. 3b is a schematic view of the terminal in FIG. 3a showing a segmentation.

FIG. 3c is a schematic view of the terminal in FIG. 3a showing another segmentation.

FIG. 4 is a schematic view of the memory structure of a color scheme table according to the invention.

FIG. 5 is a schematic view of the memory structure of a status, segment and color scheme relationship according to the invention.

FIG. 6 is a schematic view of the memory structure of a status, segment and color scheme relationship according to the invention in a specific use case.

FIG. 7 is a flow chart showing a method of showing current status using LEDs according to the invention.

### DETAILED DESCRIPTION OF EXAMPLE EMBODIMENTS

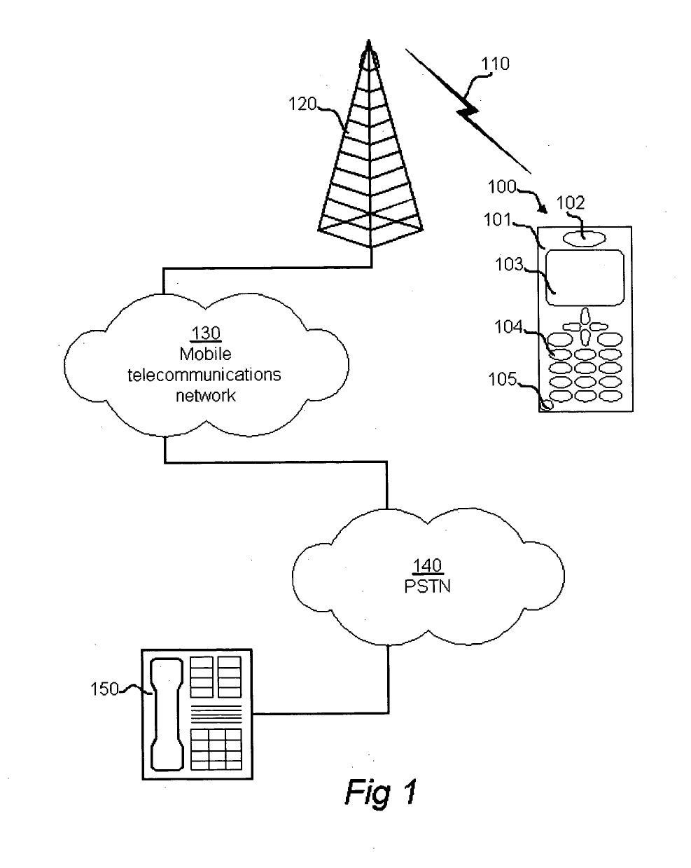

Before giving a detailed description of the embodiments shown in FIGS. 3, 4, 5, 6 and 7, FIG. 1 will provide an overview of a telecommunication system and a mobile communications terminal used therein, as one example of an electronic device in which the present invention may be included.

In the telecommunication system of FIG. 1, a mobile communications terminal 100 is connected across a wireless communication link 110 to a base station 120 of a mobile telecommunications network 130. The mobile telecommunications network 130 is connected to another telecommunications network 140, a public switched telephone network (PSTN). In this way, a user of the mobile communications terminal 100 may communicate with another user of a stationary telephone 150. The mobile communications terminal may be any commercially available device—such as a mobile (cellular) telephone, a portable digital assistant (PDA) or a communicator which is adapted for any known mobile telecommunications system, such as GSM, UMTS or D-AMPS.

As is well known in the art, the mobile communications terminal 100 comprises an apparatus housing 101, a loudspeaker 102, a display 103, a keypad 104 and a microphone 105. In addition, but not shown in FIG. 1, the mobile communications terminal 100 comprises various components, such as a built-in or external antenna, a radio transceiver, a speech encoder/de-coder, a channel encoder/decoder, a processing device (CPU), an electronic memory, and various segments of software code, which are stored in the memory and are executed by the processing device so as to perform the various functions and operations of the mobile communications terminal 100.

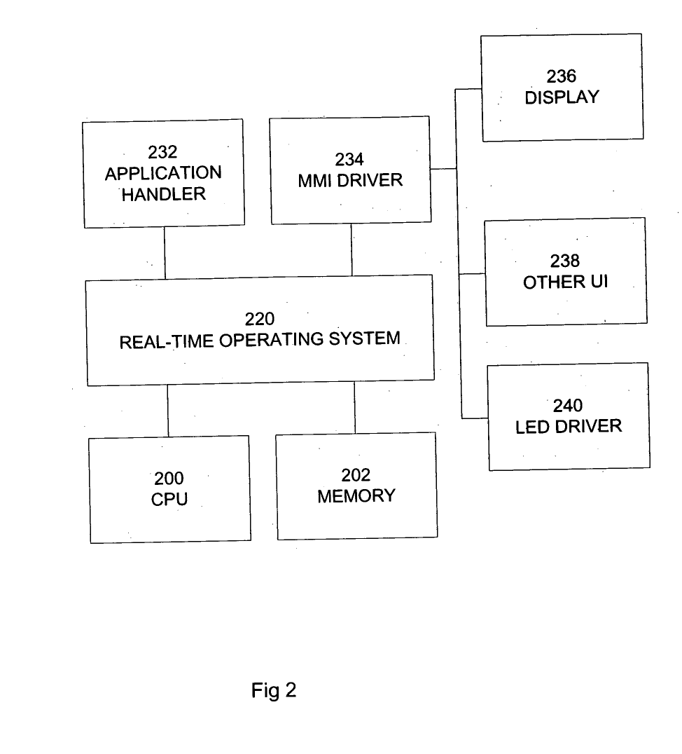

FIG. 2 illustrates one embodiment of a mobile communications terminal according to the invention. A controller 200 is responsible for the overall operation of the mobile communications terminal and is preferably implemented by any commercially available CPU (“Central Processing Unit”), DSP (“Digital Signal Processor”) or any other electronic programmable logic device. The controller 200 has associated electronic memory 202 such as RAM memory, ROM memory, EEPROM memory, flash memory, or any combination thereof. The memory 202 is used for various purposes by the controller 200, one of them being for storing data and program instructions for various software in the mobile communications terminal. The software includes a real-time operating system 220, man-machine interface (MMI) drivers 234, an application handler 232 as well as various applications. The MMI drivers 234 cooperate with conventional MMI or input/output (I/O) devices, including a display 236 and various mechanical keys 238 such as volume control as well as various other I/O devices such as a microphone, a speaker, a vibrator, a joystick, a ringtone generator, an LED indicator, etc. As is commonly known, a user may operate the mobile communications terminal through the man-machine interface thus formed. The MMI drivers 234 also include LED drivers 240 that handle multi-color LEDs specifically associated with the display 236 and control which of these will be lit and in what color.

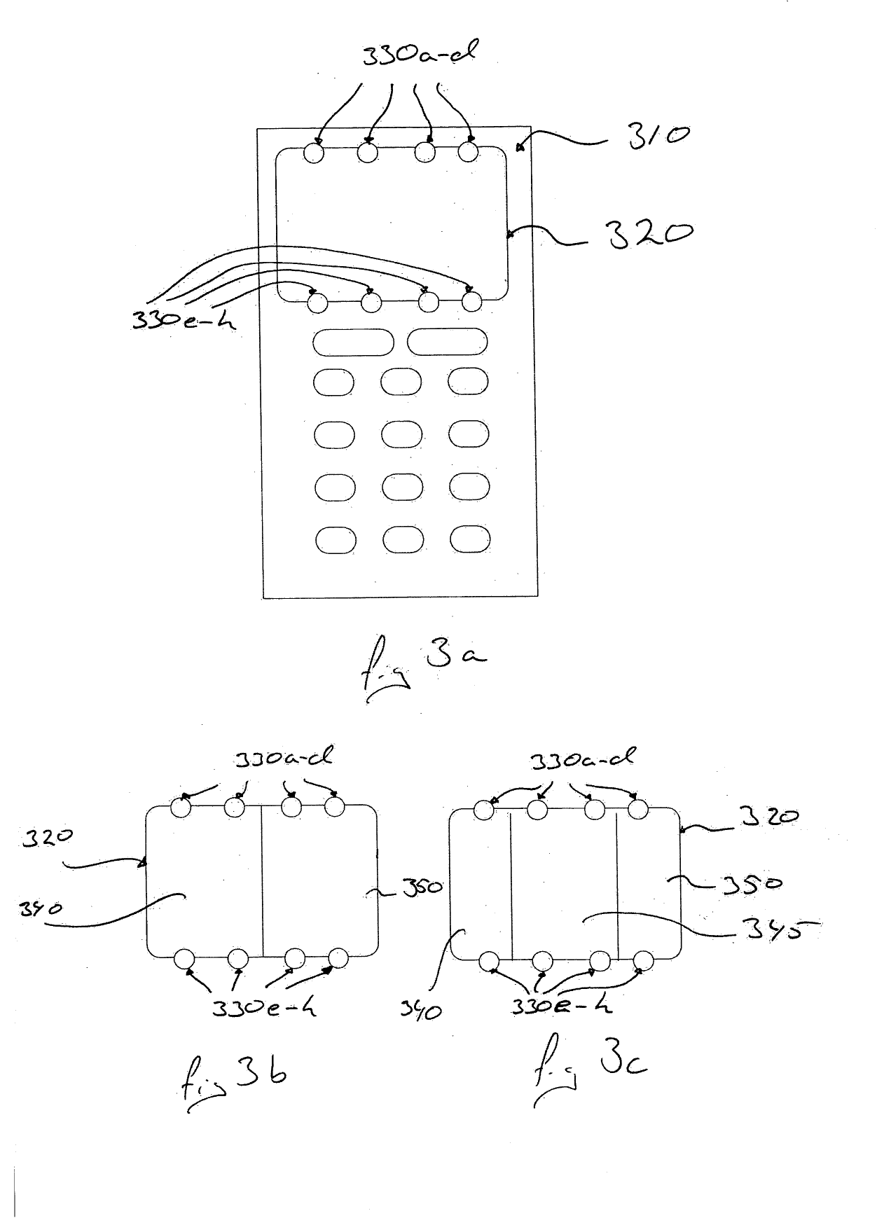

FIG. 3a shows a mobile communications terminal 310, such as a mobile phone, according to the present embodiment. The mobile telephone 310 has eight light emitting diodes. (LEDs) 330a-h distributed around a display 320, four diodes 330a-d on the top side and four 330e-h on the bottom side. The diodes 330 are multicolor LEDs and can shine in a number of colors, perhaps even the whole or most of the visible spectra. This provides for the possibility of illuminating the display 320 in different colors and as more than one diode is used, different parts of the screen can be illuminated in different colors thus making it possible for users to further personalize their mobile phone 310. In this example eight different color segments are possible, one for each diodes but preferably the display is only divided in two, one left and one right, or three color segments, one left, one middle and one right segment by grouping the diodes in groups. FIG. 3b shows a display 320 with eight diodes 330a-h where diodes 330a, b, e and f are grouped in a left segment 340 and 330c, d, g and h are grouped in a right segment 350. FIG. 3c shows a display 320 with eight diodes 330a-h where diodes 330a and e are grouped in a left segment 340, diodes 330b, c, f and g are grouped in a middle segment 345 and diodes 330d, and h are grouped in a right segment 350.

Thus a patriotic German user could have the screen illuminated in the colors black, yellow and red to show his nationality and another user could have the colors of his favourite football team, say green and blue. This provides the user with ample opportunity to personalize his or her mobile communications terminal and still making it possible for the manufacturer to produce cheap models as multi colored diodes are much cheaper than a color display.

Naturally the diodes 330 can be placed all around the display 320 on either side and not just on the top and bottom side. Other segmentations are also possible, and different arrangements of the diodes provide even more possibilities. It is also clear that even though only vertical segments are disclosed, horisontal and both vertical and horisontal segmentations, such as a matrix structure, are possible.

The segmentations need not be static or preset, but can be user defined, changeable and dynamic. The segmentations could also be interswitchable and/or intermixed. The diodes could be set to alter between a couple of colors and also segmentations making it possible to have the display alternately being illuminated in black, yellow and red and then in green and blue.

Other effects such as alternate blinking, running lights and stroboscopic effects could also be used.

In another embodiment the dynamic setting of the diodes' color scheme could be coupled to the mobile phone's sound generator. This would enable the phone to blink and show other fun, disco-like effects when set to blink to the beat of a music file or tune being played.

The color segments, be it divided screen or full screen, could also be used to signal a certain status. This would help free up the screen as some indicators would not need to be shown. It would also make it much easier for the user to see the status change as it would be more visible from a distance.

Examples of different statuses could be battery low or memory full, but could also be events like incoming call or newly arrived message.

In one embodiment the color scheme listed below could be used.

| Color | Status |
|---|---|
| Red | Missed call |
| Blue | Message unread |
| Yellow | Incoming call |
| Green | Memory full |
| One diode | Battery low |
| showing | |
| red, the | |
| others turned | |
| off | |

As seen from the color scheme above, different diodes could be set to shine in different colors to signal different statuses.

In this patent application we consider details such as the identity of the caller to be part of the status or a status on its own and different color codes or colors could be assigned to some or all phonebook entries.

In an embodiment the diode color segments could be set to indicate different statuses at the same time. Thus, if the user had a special group of important contacts like his manager and top clients and had assigned the color red to this group the display could be set to shine, assuming two segments, in red in the left segment and yellow in the right segment to indicate an incoming call from an important contact and to shine in red in the left segment and blue in the right segment to indicate that a message from an important contact has arrived. In this example the left segment shows the identity and the right segment shows the related activity.

Dynamic behavior could also be used to indicate further status information. Running lights could signal an urgent incoming call or message and the color scheme used could indicate which group the caller belongs to, provided that the mobile communications terminal is arranged to detect the priority or urgency of an incoming call or message.

The color segments or diode grouping could also be intermixed so that every other diode shows one color (or possibly being turned off) and the others showing another. This coding could also be dynamic so the diode groups or intermixed color segments could vary or alternate colors.

In one embodiment the various segmentations and their corresponding color schemes are stored in tables in the memory. As an event occurs or a new status is brought about the tables are searched for a corresponding color scheme which is then effected.

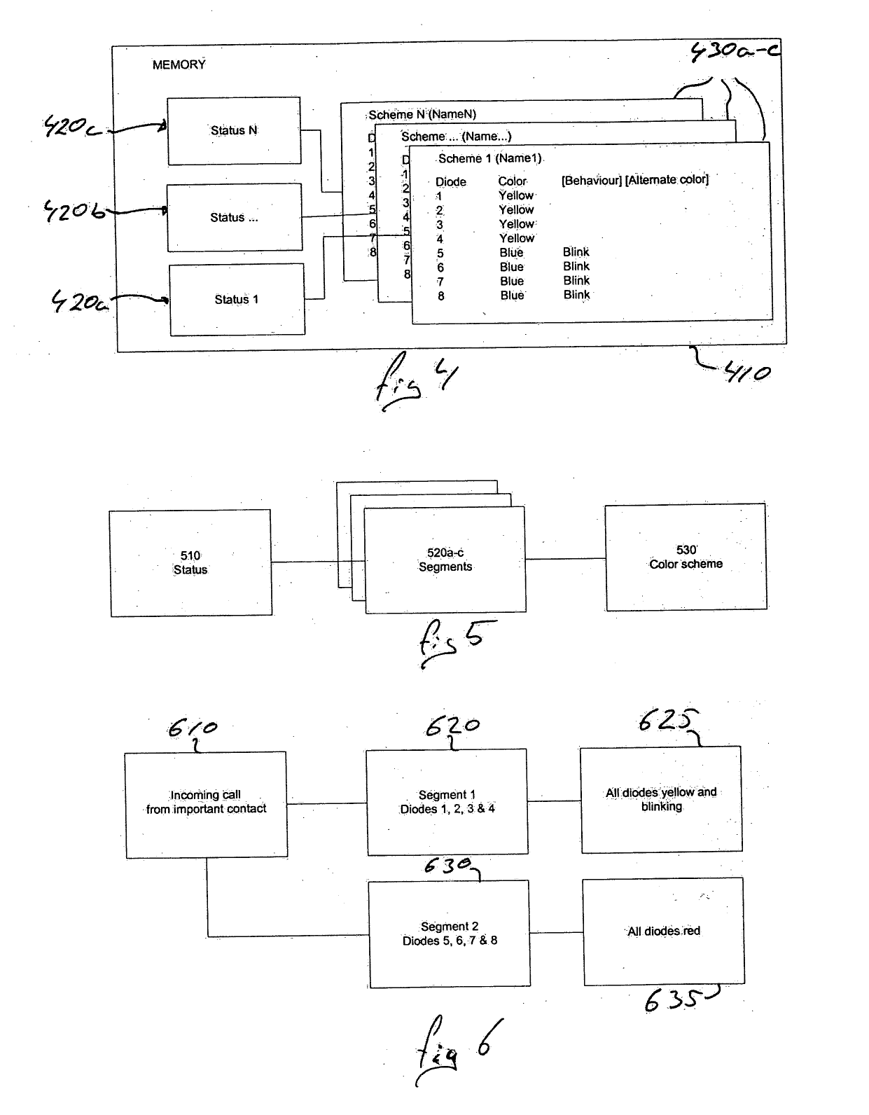

FIG. 4 shows how the tables could be stored in the memory 410 of a mobile communications terminal relating statuses 420a-c with color schemes 430a-c which are then defined as regards to the color and behavior of the various diodes.

It could also be possible to have color schemes wherein a color and possibly a behavior is specified for all diodes belonging to the segment that uses each color scheme and wherein segments are then assigned to statuses. FIG. 5 shows one block diagram of such a structure. A Status 510 has one or more Segments 520a-c and each Segment 520a-c has a Color scheme 530. It is also possible to have alternating or varying color schemes 530 associated with a segment 520. FIG. 6 shows how this model would look like in the use case of an incoming call from a contact listed as important. The status 610 has two segments 620, 630 with different color schemes 625, 635. Also referring to FIG. 3b the left segment 340 consists of four diodes 330a, b, e and f and are all set to blink with yellow light indicating that a call is incoming and the right segment 350 also has four diodes 330c, d, g and h all set to shine in red indicating that the caller belongs to the group of important contacts.

Note that in this example the status is actually a congregated status, that is the status is dependent on many variables considered statuses in this application. In this example the two sub statuses are 1) incoming call and 2) caller belongs to a specific group, namely Important.

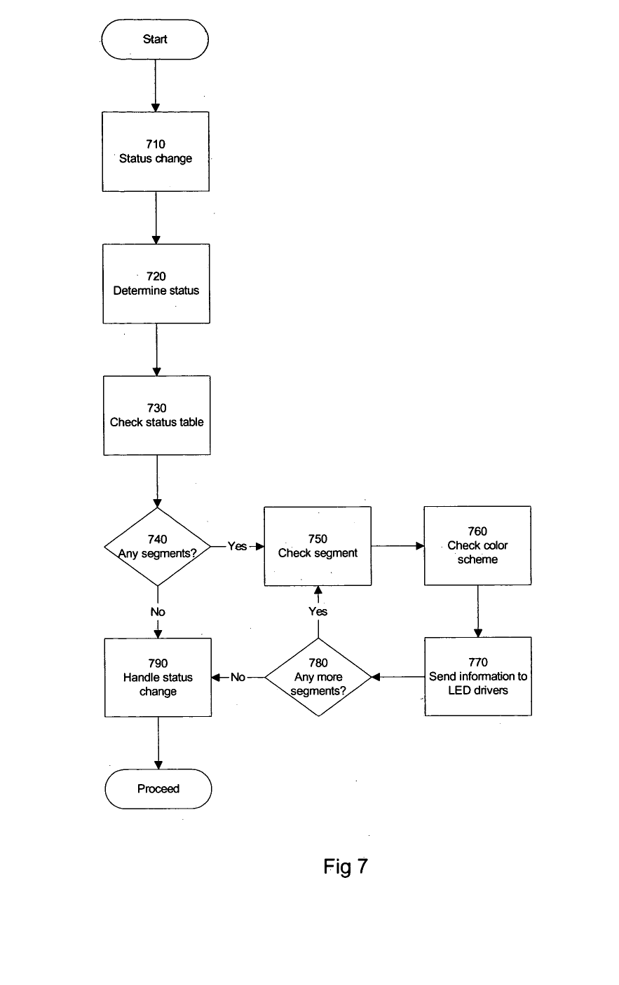

If we look at FIG. 7 in combination with FIG. 2 we can see that as an event or status change happens (710) the controller 200 determines (720) the status and checks (730) the status table stored in the memory 202 to find the corresponding segmentations and color scheme pairs (740) by first finding the segmentations (750) and their correponding color schemes (760) and feeding this information (770) to the LED drivers 240 in turn. The LED drivers 240 makes the various diodes act according to their color scheme as the information is passed to them. The controller 200 then proceeds with handling the status change (790) if needed before proceeding.

The skilled person should realise that the aspect of the present invention of indicating or signalling various stauses on the display using colors and different behaviours could also be implemented using a color display albeit this would provide a more expensive solution. The segmentations would then not be implemented using groups of diodes but a division of the screen and the color schemes would be orientated around relative coordinates instead of relative diode numbers.

The invention has mainly been described above with reference to a few embodiments. However, as is readily appreciated by a person skilled in the art, other embodiments than the ones disclosed above are equally possible within the scope of the invention, as defined by the appended patent claims.

1. A mobile communications terminal comprising a display and at least one multi color light emitting diode provided adjacent to the display.

2. A mobile communications terminal according to claim 1 wherein said at least one multi color light emitting diode is arranged to illuminate the display according to a color scheme.

3. A mobile communications terminal according to claim 1 having more than one multi color light emitting diode which are grouped in at least a first and a second group, the light emitting diode(s) in the respective group being set to emit light according to a color scheme for each of said at least first and second groups.

4. (canceled)

5. A mobile communications terminal according to claim 2 having a status and wherein the color scheme is selectable depending on said status.

6. A mobile communications terminal according to claim 3 having status and wherein the at least one (multicolor light emitting diode) group is selectable depending on said status.

7. A mobile communications terminal according to claim 5 wherein the status is a congregated status consisting of more than one status.

8. A mobile communications terminal according to claim 6 wherein the status is a congregated status consisting of more than one status.

9. A mobile communications terminal according to claim 1 wherein the mobile communiations terminal is a mobile phone.

10. A mobile communications terminal having a status and comprising display means aranged to be illuminated in at least one color and the at least one color is selectable depending on said status.

11. A mobile communications terminal according to claim 10 wherein said at least one color is dependent on a color scheme and said color scheme is selectable depending on said status whereby said at least one color is selected accordingly.

12. A mobile communications terminal according to claim 10 wherein the display means are aranged to be illuminated in at least one segment and the at least one segment is selectable depending on said status.

13. A mobile communications terminal according to claim 10 wherein the status is a congregated status consisting of more than one substatuses.

14. A mobile communications terminal according to claim 12 wherein the at least one segment has a color scheme and each of the at least one segment and its color scheme are selectable depending on one of the substatuses of said congregated status.

15. A mobile communications terminal according to claim 10 wherein the display means comprises a display and light emitting diode means that can be set to shine in at least one color.

16. A mobile communications terminal according to claim 15 wherein the light emitting diode means comprises at least one multi color light emitting diode.

17. A mobile communications terminal according to claim 10 wherein the display means comprises a color display.

18. A mobile communications terminal according to claim 10 where in the mobile communiations terminal is a mobile phone.

19. (canceled)

20. A method of illuminating a display (320) of a mobile communications terminal comprising the steps of achieving information relating to a current status of the mobile communications terminal, selecting a color depending on said current status to illuminate the display in.

21. A method of illuminating a display of a mobile communications terminal according to claim 20 where in the step of selecting a color includes the intermediate step of selecting a color scheme depending on said status and from this color scheme selecting said color.

22. (canceled)

24. A method of illuminating a display of a mobile communications terminal according to claim 20 wherein the step of achieving information relating to a current status includes the step of achieveing information relating to more than one substatus of said current status, and the step of selecting a color includes the intermediate step of selecting a color scheme depending on the substatuses and from this color scheme selecting a color.

25. A method of illuminating a display of a mobile communications terminal according to claim 20 wherein the step of achieving information relating to a current status includes the step of achieveing information relating to more than one substatus of said current status, and the step of selecting a color includes the intermediate step of dividing the display in at least one segment each depending on one of said substatuses and selecting a color for each segment depending on the asociated substatus.

26. A method of illuminating a display of a mobile communications terminal according to claim 20 wherein the step of selecting a color includes the intermediate step of dividing the display in at least one segment depending on said status and selecting a color for each segment.

27. A method of illuminating a display of a mobile communications terminal according to claim 26 wherein the step of selecting a color includes the intermediate step of assigning a color scheme to the at least one segment each and from these at least one color schemes selecting a color for that segment depending on said status.
